(19) United States
(12) Patent Application Publication
(10) Pub. No.: US 2025/0317438 A1
(43) Pub. Date: Oct. 9, 2025

(54) SYSTEMS AND METHODS FOR USE IN BIOMETRIC-ENABLED NETWORK INTERACTIONS

(71) Applicant: MASTERCARD INTERNATIONAL INCORPORATED, PURCHASE, NY (US)

(72) Inventors: Florent Hay, Laeken (BE); Aaron Shortell, Long Island City, NY (US); Charl Frederik Botes, Parrish, FL (US); Qing Cao, Purchase, NY (US)

(21) Appl. No.: 18/629,292

(22) Filed: Apr. 8, 2024

(51) Int. Cl. H04L 9/40

(52) U.S. Cl. CPC H04L 63/0861

(57) ABSTRACT

Systems and methods are provided for facilitating network interactions based on user biometrics. One example computer-implemented method includes receiving, from a server, a validation request for a biometric-initiated interaction between a user and a first party, where the validation request includes an attestation by a biometric service provider (BSP), and retrieving, by a computing device, a public key for the BSP. The method also includes validating, by the computing device, a signature of the attestation based on the retrieved public key, and returning, by the computing device, a validation result to the server, whereby the server initiates an authentication request for the biometric interaction based on the validation result.

### FIELD

The present disclosure generally relates to systems and methods for use in biometric-enabled network interactions (e.g., for facilitating such interactions, etc.).

### BACKGROUND

This section provides background information related to the present disclosure which is not necessarily prior art.

Users are known to initiate interactions with parties in various manners. For example, a user (e.g., a consumer, etc.) may present a physical card, or other device, to a first party, to initiate payment from an account associated therewith to purchase a good or service from the first party. The card or other device is tied to the account, whereby associated information is delivered from the card or other device (e.g., an account number, etc.) to the first party to initiate the payment to purchase the good or service.

### BRIEF DESCRIPTION OF DRAWINGS

The drawings described herein are for illustrative purposes only of selected embodiments and not all possible implementations, and are not intended to limit the scope of the present disclosure.

FIG. 1 illustrates an example system of the present disclosure suitable for use in facilitating biometric-enabled network interactions;

FIG. 2 is a block diagram of an example computing device that may be used in the system of FIG. 1; and

FIG. 3 is a flow diagram of an example method, which may be implemented in connection with the system of FIG. 1, for facilitating a biometric-enabled network interaction based on an attestation from a biometric service provider (BSP).

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When users interact with first parties to purchase products (e.g., goods, services, etc.), the users may pay for the products through one or more accounts. In doing so, the users present cards or other devices (e.g., digital wallets, etc.) to first parties (e.g., merchants, etc.) in order to present credentials indicative of the accounts to fund the purchases to the first parties. Such presentment of credentials, though, may be cumbersome for both the users and the first parties, depending on the number of users purchasing products and manners of presenting the credentials. Additionally, unauthorized access to the cards, or the digital wallets, may provide a basis for a breach of security, where unauthorized purchases, and other forms of fraud, may be perpetrated. What's more, the addition of biometric-initiated pay is a technical advance whereby a person presents a biometric in lieu of the card or other device. However, related assurances are inadequate in some instances, where the potential for unauthorized purchases, inadequate biometric verification, and forms of fraud still remains a technical problem. That said, a technical solution is contemplated by the inventors hereof to such problem(s).

Uniquely, the systems and methods herein leverage network-based assurances to enhance security associated with biometric-initiated pay interactions.

In particular, when a biometric is presented to initiate payment for an interaction at a first party, the biometric is submitted and resolved by a biometric service provider (BSP) into a biometric identifier (or biometric ID) and a BSP identifier, which (e.g., together, etc.) form an attestation signed by a key specific to the BSP. The attestation is submitted to a biometric identification verification platform (BIVP), for example, through an authentication scheme. The biometric identification verification platform validates the attestation (and potentially, transaction data) and provides a value indicative of validation back to the first party (and potentially a scoring related to the biometric, or resolution of the biometric, if desired or required, etc.). The first party may then initiate authorization of the interaction, where the value indicative of validation, etc., is included as part of the authorization request, and relied on (and/or accounted for) as part of authorization of the interaction.

In this manner, the biometric identification verification platform leverages authentication infrastructure to define further assurances of biometrics and/or BSPs (and potentially, transaction data) in connection with biometric-initiated payments, and in this example, through leveraging existing enhanced authentication. As such, technical security associated with the biometric-initiated interaction is substantially enhanced.

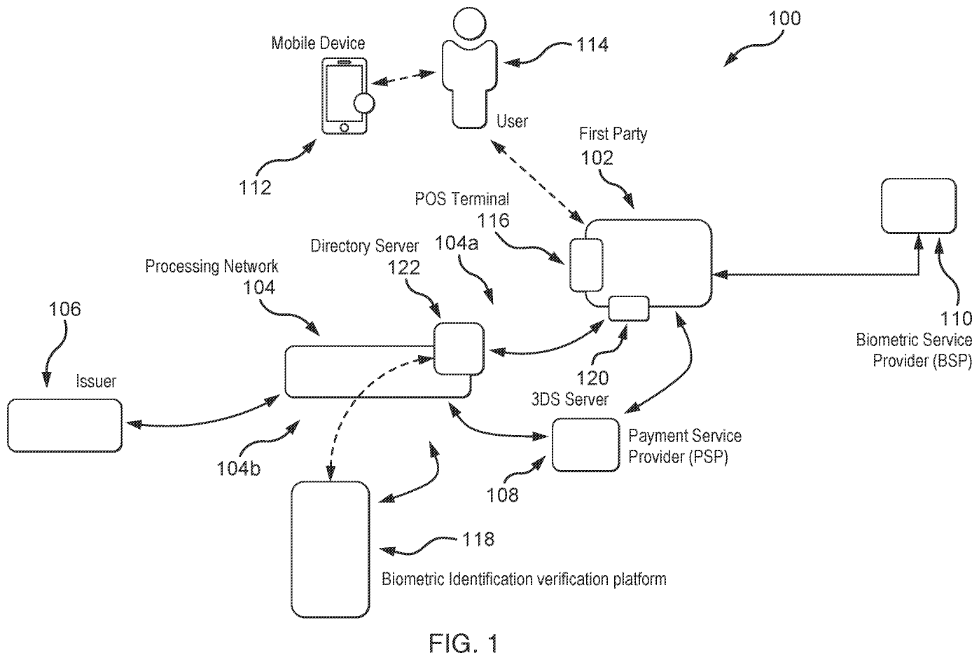

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between first parties/merchant(s) and/or payment network(s) in the system 100, types and/or features of card or other devices employed in the system 100, etc.

As shown in FIG. 1, the illustrated system 100 generally includes a first party 102, a processing network 104, an issuer 106, a payment service provider (PSP) 108 associated with the first party 102, and a biometric service provider (BSP) 110, each of which is coupled to (and is in communication with) one or more network(s) (as indicated by the arrowed lines in FIG. 1). The one or more network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, one network may include a private payment network made accessible by the processing network 104 to the issuer 106 and, separately, the public Internet, which may provide interconnection between one or more of the first party 102 and a communication device 112 associated with a user 114, etc.

The first party 102 of the illustrated system 100, in general, offers products (e.g., goods, services, etc.) for sale and/or sells products to users, including the user 114 (whereby, in this example, the first party 102 may be a merchant, etc.). In this example embodiment, the first party 102 includes either a brick-and-mortar store (e.g., a physical store location, etc.) or a virtual merchant location, such as, for example, a website, network-enabled application, etc. In either instance, the first party 102 permits, through the location, the user 114, for example, to browse products and to purchase products.

As shown in FIG. 1, the first party 102 includes a point-of-sale (POS) terminal 116 which, among other things, is configured to compile and transmit authorization messages for interactions funding the purchase of products from the first party 102. While FIG. 1 includes a POS terminal 116 that is generally disposed at the first party 102, the POS 116 may be embodied in a website or other network communication enabled application to interact with the user 114 in connection with an interaction. Further, the POS terminal 116 also includes, or in this embodiment is connected to, a biometric capturing device (not shown). The biometric capturing device may include, for example, a camera (e.g., a camera device capable of taking a biometric scan of a face, a hand, a finger, etc.), a fingerprint scanner, etc. The biometric capturing device may be included physically within, at least partially, the POS terminal 116, or may be separate therefrom, or connected (wired, wirelessly, etc.) to the POS terminal 116, etc. It should be understood that in certain embodiments, the biometric capturing device may be part of another computing device (e.g., device 112, etc.) configured to capture a biometric, which may then be passed to the first party 102 (e.g., in an e-commerce interaction, etc.).

Further, the first party 102 is associated with the PSP 108. The PSP 108 is configured to enable the first party 102 to accept electronic payments for products. It should be understood, for example, that the PSP 108 is configured to communicate with the processing network 104, in this example embodiment, and also, financial institutions, such as, for example, an acquirer associated with the first party, as an intermediate between the first party 102 and processing network 104 and/or the acquirer. In addition in the illustrated system 100, the issuer 106 is associated with the user 114, and configured to issue an account (e.g., a debit account, a credit account, a prepaid account, a checking account, etc.) to the user 114 to use in funding interactions, including with the first party 102.

With continued reference to FIG. 1, the processing network 104 is separated into two networks, generally, in this exemplary embodiment, a processing authentication network 104a and a processing authorization network 104b.

In this embodiment, the processing authentication network 104a is configured consistent with one or more enhanced authentication schemes, such as, for example, the EMV 3DS protocol (see, e.g., https://www.emvco.com/emv-technologies/3d-secure/, which is incorporated herein by reference), etc.). In particular, as shown, the processing authentication network 104a includes a 3DS server 120 and a directory server 122. The 3DS server 120 is incorporated in and/or associated with the first party 102, whereby reference herein to the first party 102 and the 3DS server 120 may be interchangeable. The directory server 122 is associated, in this example, with the processing network 104 (e.g., MASTERCARD, VISA, etc. associated networks) (e.g., the processing authentication network 104a, etc.), and is configured as described below. It should be appreciated that the processing authentication network 104a may further include an access control server (ACS) (not shown), which is incorporated in and/or is part of the issuer 108. In addition, while the 3DS server 120 is part of the processing authentication network 104a, the 3DS server 120 may reside, as illustrated in FIG. 1, in full or in part, at/in the first party 102. Or, in other embodiments, the 3DS server 120 may reside, in full or in part, at/in the PSP 108.

Further, in this exemplary embodiment, the 3DS server 120 and directory server 122 are configured to communication through, for example, the Message Extension field of the EMV 3DS protocol. It should be appreciated that a dedicated field in the EMV 3DS protocol may be employed in other embodiments. In still other embodiments, relevant communications, as describe below, may leverage one or more non-3DS protocols (e.g., application programming interfaces (APIs), etc.), etc.

In this exemplary embodiment, the processing authorization network 104b is configured, in connection therewith, to coordinate messaging between the PSP 108 and the issuer 106 to provide authorization of interactions, whereby the user 114 funds the purchase of one or more products, by and between the account of the user 114 and an account of the first party 102 (e.g., issued by an acquirer (not shown), etc.). In this manner, the processing authorization network 104b is configured to communicate, via the ISO 8583 standard, or ISO 20022 standard, with the issuer 106 and the PSP 108, etc.

While the processing authentication network 104a and the processing authorization network 104b are illustrated as associated in FIG. 1 (e.g., by integration of the directory server 122 in the processing authorization network 104b, etc.), it should be appreciated the networks 104a, 104b may be wholly or partially separate in other embodiments, etc. And, in at least one embodiment, the processing authentication network 104a may be omitted, whereby the biometric identification verification platform 118 (described more below) is configured to communicate with the first party 102, the issuer 106, etc., via one or more APIs, or other suitable modes of communication, etc.

With continued reference to FIG. 1, the device 112 is associated with the user 114 and may include any suitable device (e.g., a mobile device, another device, etc.). The device 112 is more broadly referred to as an enrollment device, or enrollment management device, which may or may not be mobile, and may or may not be specific to the user 114. In this example embodiment, the device 112 is illustrated as a smartphone. However, the device 112 may be a different device (either mobile or not) in other embodiments, including, for example, a laptop computing device, a tablet device, a desktop computing device, or other device, etc.

With continued reference to FIG. 1, in this example embodiment, the first party 102 is configured to participate in biometric-initiated pay, in which the user 114 or other users present biometrics in lieu of payment cards, digital wallets, etc., to initiate funding of interactions between the first party 102 and the user(s), as explained more below.

Based on the above, the first party 102 is associated with at least the BSP 110. The BSP 110 is configured to enable the first party 102 to participate in biometric-initiated transactions and further to participate in enrollment of users (e.g., the user 114, etc.) for biometric-initiated pay. What's more, in this example embodiment, the BSP 110 is configured to onboard with the biometric identification verification platform 118. In doing so, the biometric identification verification platform 118 is configured to review, verify, and approve the BSP 110 to be onboarded (e.g., through various processed related to the trust, quality, etc., associated with the biometric matching performances, security, etc.). As part of onboarding, the BSP 110 is configured to generate a private-public key pair, based on one or more cryptographic algorithms, to store the private key in a memory, and to transmit the public key and an identifier specific to the BSP 110, i.e., a BSP ID specific to the BSP 110, to the biometric identification verification platform 118. The biometric identification verification platform 118 is configured, in turn, to store the public key along with the BSP ID in a memory, to be used to verify subsequent attestations computed by the BSP 110.

That said, the biometric identification verification platform 118, in this example embodiment, is configured to perform the operations related to biometric-initiated pay as described herein. Relatedly, the biometric identification verification platform 118 may be a standalone party (e.g., an independent service, etc.). It should be appreciated that the biometric identification verification platform 118 may be integrated in whole or in part in other parties/devices of FIG. 1. For example, the biometric identification verification platform 118 may be integrated in the processing authentication network 104a (e.g., in the directory server 122, etc.) in one or more embodiments, or integrated into the processing authorization network 104b in other embodiments. In one particular example, the biometric identification verification platform 118 may be incorporated, in whole or in part, in the MASTERCARD ID Check network, as a processing authentication network, which may be separate from, in communication with, or integrated, in whole or in part, with the MASTERCARD authorization network 104b, etc.

Referring again to enrollment for biometric-initiated pay, for example, the user 114 decides to enroll for biometric-initiated pay at the first party 102, whereby the user 114 initiates an option to enroll at a location of the first party 102 (e.g., at a physical location or a virtual location, etc.) through the device 112 (e.g., via a digital wallet, etc.) and through the POS terminal 116, etc. In response to the initiation, the first party 102 is configured to capture a biometric of the user 114, for example, via a biometric capturing device of the POS terminal 116, the device 112, etc. As part thereof, the first party 102 is configured to perform one or more quality checks, such as, for example, a liveness check (e.g., for a facial biometric, etc.), a size of the biometric, a clarity of the biometric, etc., and to forward the biometric to the BSP 110 (when the quality check(s) is/are satisfied). The biometric may include a facial image, fingerprint, palm print, or other suitable biometric.

The first party 102 is configured to communicate the biometric to the BSP 110, and otherwise communicate with the BSP 110, for example, through an API exposed to the BSP 110 and/or a software development kit (SDK) from the BSP 110 and integrated with the first party 102 (e.g., virtual location, POS terminal 116, etc.). Upon receipt of the biometric, the BSP 110 may be configured to perform one or more biometric quality checks to ensure quality, sufficiency, etc. of the biometric and/or compliance with biometric standards of the BSP 110, etc.

Upon successful completion of the quality check(s), if applicable, the BSP 110 is configured to generate a biometric template from the biometric, to generate a unique biometric ID for the biometric and the user 114 (e.g., unique as to each other biometric known to the BSP 110, etc.), and to store (e.g., in memory associated with the BSP 110, etc.) the biometric template linked to the biometric ID as a biometric reference to the same, thereby binding the biometric ID to the biometric reference. Also, in this example embodiment, the BSP 110 is further configured to generate a BSP attestation for the biometric ID and to return the BSP attestation to the first party 102. The BSP attestation includes, among other things, the biometric ID, additional data related to the received biometric or user 114, etc. and a signature using the private key of the BSP 110 (i.e., the private key of the key pair of which the public key is shared with the biometric identification verification platform 118). The additional data may include, without limitation, biometric modality (e.g., palm, face, iris, etc.), BSP profile ID, wallet ID, biometric enrollment timestamp (Epoch), BSP transaction ID, certification and compliance ID, etc.

It should be understood that where the quality check(s) fail, the BSP 110 may be configured to request that the biometric capture be repeated, whereby the above is further repeated until the quality check(s) are successful.

In turn, the first party 102 is configured to solicit an account to be associated with the biometric and to capture account details and other identifying information from the user 114, for example, via the POS terminal 116, the device 112, etc., when presented by the user 114. The account is identified through account details, which may include, without limitation, an account number (e.g., a primary account number (PAN), etc.), an expiration date, a card verification code (CVC), a billing address, etc. The first party 102 is configured to encrypt the account details and to transmit the encrypted account details and the BSP attestation to the PSP 108, as a request to enroll the user 114 in biometric-initiated pay.

In turn, the PSP 108 is configured to initiate a verification of the account being enabled for biometric-initiated pay, through the 3DS server 120, whereby the 3DS server 120 is configured to determine whether the account number for the account to be associated with the biometric is within a range of account numbers enabled for biometric-initiated pay, to generate a transaction ID for the transaction for the determination, and, when enabled, to return a response indicative of the enablement of the account and the transaction ID to the PSP 108.

Next, the PSP 108 is configured to initiate an identify and verify (ID&V) sequence, through the processing authentication network 104a. That is, the PSP 108 is configured to submit a non-payment authentication request to the 3DS server 120, based on the account details for the account issued to the user 114. In this way, the PSP 108 is configured to ensure that the account being associated with the biometric does in fact belong to the user 114 (who is a genuine user). The ID&V may include different forms, such as, for example, one-time-passcode (OTP) verification to a known phone number, email address, etc., of the user 112, push notification to the mobile application associated with the issuer 106 and included in the device 112, etc.

In response, the 3DS server 120 is configured to submit the authentication request or AReq to the directory server 122, which may or may not include a challenge mandate. The directory server 122, in turn, is configured to submit the AReq to the issuer 106 (or ACS thereof). An authentication response or ARes is provided back from the issuer 106 to the directory server 122, where the ARes includes challenge content, if mandated. The directory server 122 is configured to return the ARes to the 3DS server 120, which is configured to return the ARes to the PSP 108. The PSP 108 is configured to initiate the challenge, if indicated at this time, based on the challenge content in the ARes (e.g., URL, etc.), whereby the challenge request (CReq) and challenge response (CRes) are exchanged between the issuer 106 and the user 112 (e.g., at the device 112, the POS terminal 116, etc.).

The issuer 106 is configured to provide the result of the challenge in a Response Request or RReq to the directory server 122. The directory server 122 is configured to return the result to the 3DS server 120, which in turn, is configured to return the same to the PSP 108 (e.g., in response to a GET result instruction from the PSP 108, etc.). When the challenge result is successful, then, the ID&V is considered to be complete and successful.

It should be appreciated again that the above is consistent with the EMV 3DS protocol, but that other protocols associated with authentication, more generally, may be used in other embodiments.

Next, based on the ID&V, the PSP 108 is configured to transmit a second non-payment authentication request, as a request to bind the biometric to the account details.

In particular, the PSP 108 is configured to submit a binding request to the 3DS server 120, which is configured to submit the binding request, which includes the BSP attestation, BSP ID, and ID&V result (e.g., a transaction ID associated with the same, etc.), to the biometric identification verification platform 118. In turn, the biometric identification verification platform 118 is configured to retrieve the public key for the BSP 110, as previously received and stored, based on the BSP ID, etc. The biometric identification verification platform 118 is configured to then validate the signature on the BSP attestation based on the public key and to notify the 3DS server 120 of a result of the validation of the BSP attestation being successful. The 3DS server 120 is configured to then submit the authentication request to the directory server 122, which may or may not include a challenge mandate. Generally, if the challenge is completed above, it is not repeated here. If not completed above, then, the directory server 122 is configured to submit the AReq with the challenge mandate to the issuer 106, whereby the challenge is completed, as described above.

It should be appreciated that, as explained above, the biometric identification verification platform 118 may optionally be integrated in the directory server 122, for example, whereby verifying the BSP attestation and challenging the identity of the user 112 may be implemented through one or more authentication requests.

Regardless of the sequence, the BSP attestation is verified by the biometric identification verification platform 118 (e.g., standalone, or integrated in the processing authentication network 104a, etc.), and the user 112 successfully proves his/her identity (e.g., through the ID&V challenge, etc.).

Next, the 3DS server 120 is configured to instruct the binding of the biometric to the account at the biometric identification verification platform 118. In turn, the biometric identification verification platform 118 is configured to store the successful BSP attestation validation, an indication of the successful ID&V of the user 114, the account details, the biometric ID, etc. (e.g., in a mapping in memory associated therewith, etc.). In addition, the 3DS server 120 is configured to provide results to the PSP 108. In turn, the PSP 108 is configured to store the account details along with the biometric ID and the biometric reference for future biometric-initiated pay interactions (e.g., in a mapping in memory associated therewith, etc.).

It should be further appreciated that, as required or desired, the account details may be tokenized prior to recording the mapping, whereby the PSP 108 is configured to request tokenization from a token provider (not shown) and to store the token, in lieu of the account details (e.g., the PAN, etc.) in the mapping.

While the enrollment of the user 114 is described with reference to BSP 110, through the first party 102, it should be appreciated that the user 114 may enroll with other first parties and/or other BSPs to enable biometric pay at multiple parties and/or through multiple BSPs.

Subsequently, in connection with a biometric-initiated pay interaction at the first party 102, the user 114 submits a biometric in lieu of a card or other device, etc., to the first party 102. In turn, the first party 102 is configured to capture a biometric of the user 114, for example, via the POS terminal 116, or other suitable biometric capturing device, etc. The first party 102 is configured to, as above, perform one or more quality checks, such as, for example, a liveness check as the biometric is captured, etc. Upon successful quality check(s), the first party 102 is configured to generate a biometric template for the captured biometric and to submit the biometric template to the BSP 110, for example, as a request to identify the user 114. Upon receipt of the request, the BSP 110 is configured to perform one or more quality checks on the biometric template, as describe above. Upon successful quality check(s), the BSP 110 is configured to create a biometric template from the captured biometric, match the biometric template to a biometric reference stored therein, in order to identify the corresponding biometric ID. In response to successfully identifying a biometric ID based on the biometric template from the first party 102, the BSP 110 is further configured to generate an attestation, to sign the attestation with the private key, and to return the biometric ID, along with additional data as part of the signed transaction attestation, to the first party 102. Again, the additional data may include, without limitation, a biometric modality (e.g., palm, face, iris, etc.), a BSP profile ID, a wallet ID, a biometric enrollment timestamp (Epoch), a BSP transaction ID, a certification ID, and a compliance ID, etc. It should be understood that where the quality check(s) or matching fail, the BSP 110 may be configured to request that the biometric capture be repeated.

The first party 102 is configured to submit the signed attestation that contains the biometric ID and the BSP ID, etc., to the PSP 108.

In turn, the PSP 108 is configured to retrieve the account details based on the biometric ID and to submit an authentication request to the 3DS server 120. The authentication request includes, among other things, the account details, and the attestation, etc. The 3DS server 120, in turn, is configured to initiate a payment authentication request with mandate for a non-challenge.

In a first implementation, the 3DS server 120 is configured to submit a validation request to the biometric identification verification platform 118 (e.g., via API, etc.), which includes, among other things, the attestation. The biometric identification verification platform 118, in turn, is configured to retrieve the public key for the BSP 110, based on the BSP ID, and to validate the attestation based on the public key. The validation result is either successful or failed. In addition, the biometric identification verification platform 118 may be configured to score the specific type of biometric used in the transaction, or assess the confidence in the biometric and/or BSP for the transaction, etc., as part of a validation result for the request. The biometric identification verification platform 118 is configured to return the validation result (e.g., via API, etc.), which may include, for example, the transaction ID stored in enrollment or other indicator of success, to the 3DS server 120.

The 3DS server 120 is configured to then submit an authentication request, or AReq, to the directory server 122. The directory server 122, in turn, may be configured to interact with the issuer 106 based on the AReq, or not. Regardless, the directory server 122 is configured to generate a biometric authentication value or BAV, where the request includes the account details, an identifier for the first party 102 (e.g., a merchant identifier, etc.) and an issuer authentication value (IAV), etc.

In a second implementation, the 3DS server 120 is configured to submit the payment authentication request, or AReq, to the directory server 122, which is integrated with the biometric identification verification platform 118. Alternatively, the directory server 122 may be configured to submit a validation request to the biometric identification verification platform 118 (e.g., via API, etc.), which includes, among other things, the attestation. The biometric identification verification platform 118, in turn, is configured to retrieve the public key for the BSP 110, based on the BSP ID, and to validate the attestation based on the public key (and to return the validation result to the directory server 122 (e.g., via API, etc.), if separately therefrom). The validation result is either successful or failed. In addition, the biometric identification verification platform 118 may be configured to score the specific type of biometric used in the transaction, or assess the confidence in the biometric and/or BSP attestation for the transaction, etc., as part of a validation result for the request.

The directory server 122 is then in possession of the validation result, where integrated with the biometric identification verification platform 118 or, received from the biometric identification verification platform 118.

Based on a successful validation of the BSP attestation, and potentially, interaction with the issuer 106 (or ACS), the directory server 122 is configured to generate a biometric authentication value, or BAV, where the request includes the account details, an identifier for the first party 102 (e.g., a merchant identifier, etc.) and an issuer authentication value (IAV), etc.

In either implementation, the directory server 122 is configured to provide the authentication response, or Ares, to the 3DS server 120. The 3DS server 120 is configured to provide the ARes to the PSP 108.

The PSP 108 is configured to notify the first party 102 of the successful authentication of the user 114 and to initiate authorization of the transaction with the BAV. What's more, in one or more embodiments, the notification may include a personalized message to the identified user and may ask for confirmation of the transaction with the card selected, etc.

In doing so, the PSP 108 is configured to compile and transmit an authorization request for the transaction to the processing authorization network 104b, via an acquirer (not shown), with the BAV as part of the 0100 message consistent with the ISO 8583 standard. Upon receipt of the authorization request, the processing authorization network 104b is configured to validate the BAV. And, once validated, the processing authorization network 104b is configured to transmit the authorization request to the issuer 106. Once the transaction is authorized, the issuer 106 is configured to compile and transmit an authorization response for the interaction back to the PSP 108, through the processing authorization network 104b.

The PSP 108, upon authorization in the authorization response, is configured to notify the first party 102 that the interaction is authorized. The first party 102 is configured to then proceed to deliver the product to the user 114 and/or to notify the user 114 of the authorization.

While only one first party 102, one issuer 106, one PSP 108, and one BSP 110 are illustrated in FIG. 1, it should be appreciated that any number of these parts and/or entities (and their associated components) may be included in the system 100, or may be included as a part of systems in other embodiments, consistent with the present disclosure. Likewise, it should be appreciated that the system 100 and/or other system embodiments will generally include multiple users, each associated with an account and a biometric for use in biometric-initiated payments interactions with the first parties, etc.

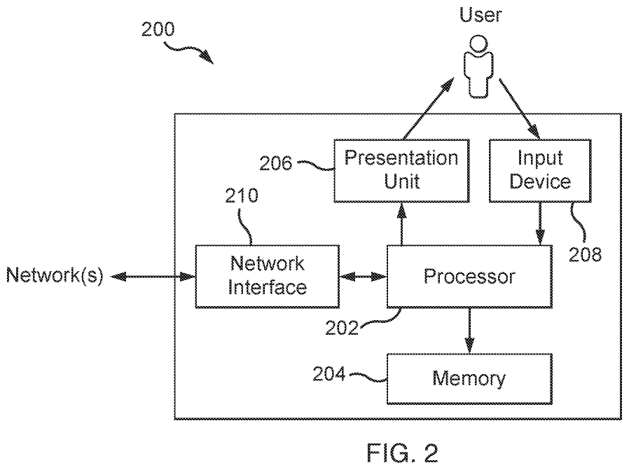

FIG. 2 illustrates an example computing device 200 that may be used in the system 100. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to operate as described herein. In the example embodiment of FIG. 1, each of the first party 102, the processing network 104, the issuer 106, the PSP 108, the BSP 110, the device 112, the POS terminal 116, the biometric identification verification platform 118, the 3DS server 120, and the directory server 122 are understood to be included in, or as being generally implemented in, at least one computing device generally consistent with computing device 200, coupled to (and in communication with) the one or more networks. However, with that said, the system 100 should not be considered to be limited to the computing device 200, as described below, as different computing devices and/or arrangements of computing devices may be used.

Referring to FIG. 2, the example computing device 200 includes a processor 202 and a memory 204 coupled to (and in communication with) the processor 202. The processor 202 (as well as the processor 128) may include one or more processing units (e.g., in a multi-core configuration, etc.). For example, the processor 202 (as well as the processor 128) may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices (e.g., EMV chips, etc.), flash drives, CD-ROMs, thumb drives, floppy disks, tapes, hard disks, and/or any other type of volatile or nonvolatile physical or tangible computer-readable media. The memory 204 may be configured to store, without limitation, biometric templates, biometrics IDs, account details, tokens, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein, whereby such performance improves operation of the computing device (as described herein) and transforms the computing device 200 into a special-purpose computing device. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, such as indicators of successful authentications, audibly or visually, for example, to a user of the computing device 200, such as the user 114 in the system 100 (e.g., at the device 112, the POS terminal 116, etc.), etc. The presentation unit 206 may include, without limitation a liquid crystal display (LCD), a light-emitting diode (LED) or LED display, an organic LED (OLED) display, an “electronic ink” display, speakers, etc. In some embodiments, presentation unit 206 may include multiple devices.

In addition, the computing device 200 includes an input device 208 that receives inputs from the user of the computing device 200 (i.e., user inputs) such as, for example, biometric inputs, etc., as further described herein. The input device 208 may include a single input device or multiple input devices. The input device 208 is coupled to (and is in communication with) the processor 202 and may include, for example, a keyboard, a pointing device, a mouse, position sensors, biometric capturing device (e.g., fingerprint sensors, camera, palm reader, etc.) or any other type of sensor, a touch sensitive panel (e.g., a touch pad or a touch screen, etc.), another computing device, and/or an audio input device, etc. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., Wi-Fi adapter, a near field communication (NFC) adapter, a Bluetooth adapter, etc.), a mobile network adapter, or other device capable of communicating to one or more different networks, including the one or more networks described above. Further, in some example embodiments, the computing device 200 may include the processor 202 and one or more network interfaces incorporated into or with the processor 202.

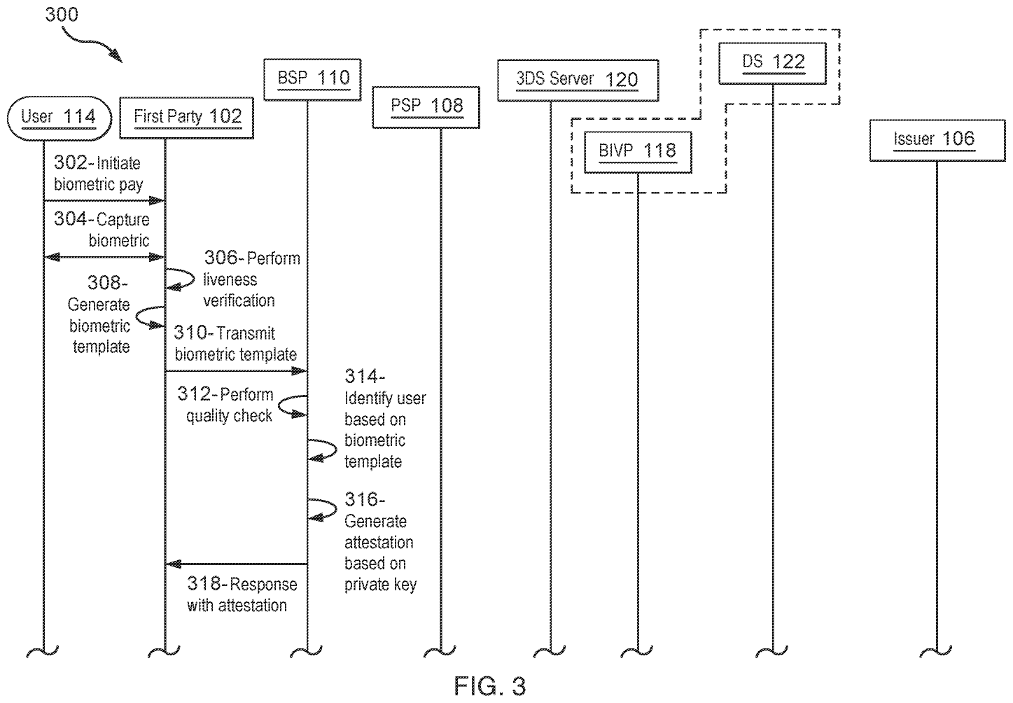

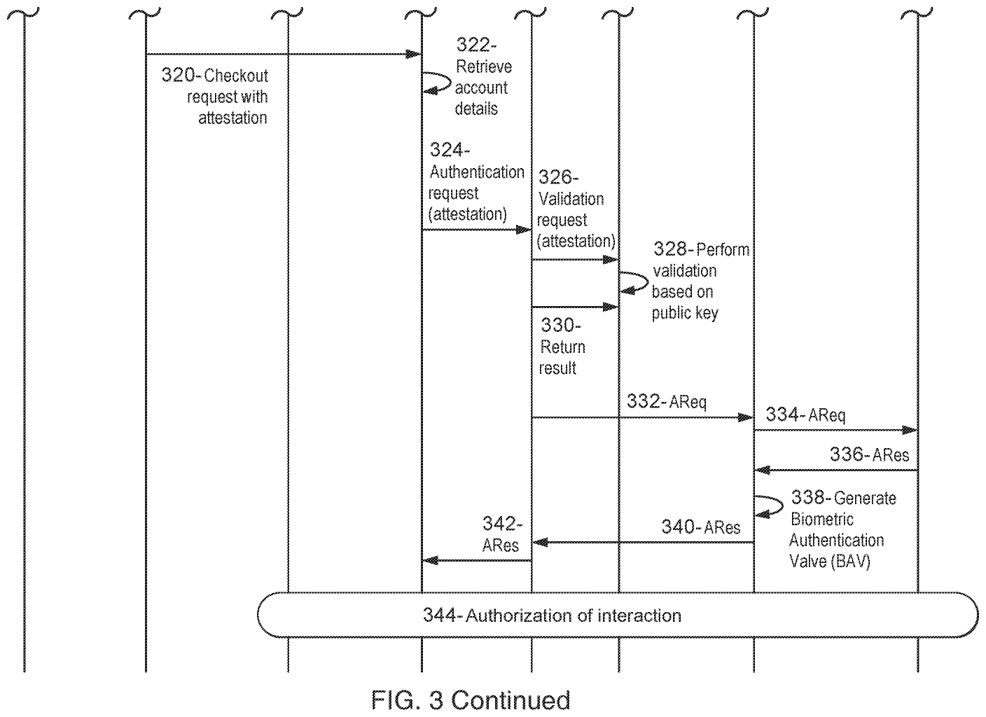

FIG. 3 illustrates an example method 300 for use in facilitating network interactions based on user biometrics. The example method 300 is generally described in connection with the PSP 108, the BSP 110, the 3DS server 120, and the biometric identification verification platform (BIVP) 118 of the system 100, and in conjunction with the other entities in FIG. 1. Reference is also made to the computing device 200 of FIG. 2. However, the methods herein should not be understood to be limited to the system 100 or the computing device 200, as the methods may be implemented in other systems and/or computing devices. Likewise, the systems and the computing devices herein should not be understood to be limited to the example method 300.

At the outset, it should be appreciated that the user 114 is enrolled for biometric-initiated pay with the first party 102, as described above, and also, that the BSP 110 has already been onboarded with the biometric identification verification platform 118, as described above.

As such, in connection with a biometric-initiated pay interaction, the user 114 is browsing products offered for sale by the first party 102 (e.g., in a physical location, or at a virtual location, etc.), and decides to purchase a product.

At 302, the user 114 initiates a biometric-initiated pay interaction by selecting an option at the terminal 116, in this example, for biometric-initiated pay (or, in other examples, through an application or web browser at the user's device 112, etc.). In response, at 304, the first party 102 (and in particular, the POS terminal 116 (via a biometric capturing device associated therewith)) captures a biometric of the user 114. The biometric may include a fingerprint, a palm print, etc., or, as in this example, the biometric includes a facial image of the user 114. In connection with the capture, the first party 102 performs, at 306, a liveness check on the user 114, which confirms that the user 114 is actually present for the capture (as compared to a still image being presented to the biometric capturing device, etc.). Next, at 308, the biometric capturing device of the first party 102 generates a biometric template from the captured biometric. The biometric template may be any suitable mathematical representation of the physiological characteristics of the user's biometric (e.g., that allows the BSP 110 to run a 1:N biometric identification matching algorithm, etc.), etc. It should be appreciated that in one or more embodiments, the captured biometric may be provided to the BSP 110, whereby the BSP 110 then generates the biometric template.

That said, after generating the biometric template, the first party 102 transmits, at 310, the biometric template, as part of a biometric-initiated pay request, to the BSP 110.

The BSP 110 receives the request from the first party 102 and performs, at 312, one or more quality checks on the biometric template. It should be appreciated that the quality checks may be specific to the BSP 110, and may be dependent on the proprietary processing and/or the modality biometrics, etc., to enable, for example, prompt matching of the biometric to a biometric ID, etc. For example, for facial recognition, a quality check may be related to the lighting conditions of the photo or video to determine if the biometric(s) captured is/are usable or not. Alternatively, it should be appreciated that the quality checks may be integrated into the biometric capturing device, which is configured, then, to perform the checks when capturing the biometrics, using an SDK from the BSP 110, etc., whereby the biometric capturing device only outputs a captured biometric (or template) when the quality checks are passed.

Based on the quality of the biometric template being confirmed, the BSP 110 identifies the user 114 based on the biometric template. In particular, the BSP 110 searches for a biometric reference, which matches the biometric template from the first party 102. The BSP 110 may include hundreds, thousands, or hundreds of thousands or more biometric references, to be considered. When a match (e.g., within applicable standards, etc.) is determined, the BSP 110 pulls the biometric ID bound to the matching biometric reference and generates, at 316, an attestation for the match. The attestation includes the biometric ID, other relevant information (e.g., BSP ID, amount of the interaction, currency of the interaction, etc.) and a signature by the private key of the BSP 110. It should be appreciated that the attestation may further include a type of the biometric (e.g., a facial biometric, a fingerprint biometric, etc.), a confidence in the matching, or other suitable data, etc. However, in example embodiments, the attestation is devoid of data that represents a biometric of the user 114 (e.g., the attestation is devoid, or does not include, actual biometric data of/for the user 114, etc.). It should also be appreciated that the attestation may include the N closest matches and associated confidence scores, as a candidate list of biometric IDs, in order to detect close matches, etc.

The BSP 110 provides, at 318, a response to the first party 102, which includes the attestation.

The first party 102 submits, at 320, a checkout request including the attestation to the PSP 108.

In turn, the PSP 108 retrieves the account details based on the biometric ID from the attestation. The PSP 108 then generates an authentication request for the interaction, which includes the account details and the attestation. The request may further include details of the interaction such as, for example, a transaction amount, a merchant identifier, etc. At 324, the PSP 108 transmits the authentication request to the 3DS server 120.

The 3DS server 120, in turn, at 326, submits a validation request to the biometric identification verification platform 118, which includes, among other things, the BSP ID and the attestation. As indicated by the dotted lines in FIG. 3, the biometric identification verification platform 118 may be integrated, in whole or in part, with the directory server 122, whereby the operations performed by the biometric identification verification platform 118 may be performed directly by the directory server 122, as part of the authentication request, or AReq (e.g., in response to AReq at step 332, etc.), as opposed to separate therefrom.

At 328, the biometric identification verification platform 118 retrieves the public key for the BSP 110, based on the BSP ID, and validates the signature of the attestation based on the public key. The validation result is either successful or failed. In addition, the biometric identification verification platform 118 may further score the specific type of biometric used in the transaction, or assess the confidence in the biometric and/or BSP for the transaction (e.g., low, medium, high, or numeric values, etc.), etc., as part of a validation result for the request. What's more, where there is a list of candidate biometric IDs, or otherwise, the biometric identification verification platform 118 may execute additional verifications such as, for example, tracking user consent for biometrics to be used at particular first parties, evaluating transaction history to determine the probability of transaction at the first party 102, etc. In connection therewith, the confidence scores, whether numeric or otherwise, may be indicative of a specific recommendation for frictionless flow (e.g., confidence score is high, etc.), or a specific recommendation for out-of-band (OOB) authentication (e.g., confidence score is low, etc.) (e.g., notifying the user 114, via the mobile application of the issuer 106 in the device 112, etc.), or otherwise, etc., whereby the recommendation may be further based on modality (e.g., palm may be more reliable than another modality, etc.), additional verification, etc. The biometric identification verification platform 118 returns, at 330, the validation result, which may include, for example, the transaction ID stored in enrollment or other indicator of success, to the 3DS server 120.

It should be understood that while the biometric identification verification platform 118 is limited to validation, scoring, etc., in this example embodiment, it may further resolve the biometric ID to account details in other embodiments (in place of the PSP 108 resolving the biometric ID).

With continued reference to FIG. 3, the 3DS server 120 submits, at 332, an authentication request, or AReq, to the directory server 122. The directory server 122, at 334, submits the AReq to the issuer 106. Optionally, in this exemplary embodiment, the issuer 106 evaluates the attestation validation and submits, at 336, an authentication response or ARes to the directory server 122. The directory server 122 in turn, at 338, generates a biometric authentication value or BAV, which is indicative of the biometric and/or validation of the same, etc., and provides the ARes, along with the BAV, to the 3DS server 120, at 340. And, at 342, the 3DS server 120 provides the ARes to the PSP 108.

The PSP 108 then initiates authorization of the interaction, at 344, through an authorization request compiled and submitted to the processing authorization network 104b, via an acquirer, as explained above. The issuer 108 receives the authorization request from the processing authorization network 104b and decides to approve or decline the transaction, based, in part, on the result for the BSP attestation validation indicated in the ARes. The issuer 106 then returns an authorization response to the processing authorization network 104b, which indicates the approval or decline of the transaction. The processing authorization network 104b returns the response to the PSP 108, via the acquirer. The PSP 108, in turn, informs the first party 102, which may then proceed in the interaction or seek alternate forms of payment, as appropriate.

With that said, the method 300 is generally described with regard to the processing authentication network 104b and the 3DS server 120. It should be appreciated, though, that in other embodiments the method 300 could be implemented independent of the 3DS server 120. For example, in such embodiments, the attestation may be included in the authorization request, whereby the issuer 106 may then validate the authentication through an API call to the biometric identification verification platform 118.

In view of the above, the systems and methods herein provide for facilitating network interactions based on user biometrics with enhanced assurances related to the biometrics. In particular, an attestation is compiled along with the resolution of a biometric in biometric-initiated transactions, which carries a private key signature of a BSP who resolved the biometric. The attestation is then validated, in connection with enhanced authentication, whereby further assurances are available to issuers of accounts to which the biometric-initiated pay interactions are directed. That is, enhanced authentication is leveraged to carry further assurance for biometric interaction, while limiting the exposure of biometric data, personally identifying data, etc. For example, the biometric data is limited to the first party and the BSP, and does not flow to the PSP or the biometric identification verification platform, in certain embodiments (e.g., where the biometric is resolved exclusively at the BSP) while each still participates in the performance and assurance of biometric interactions. What's more, the biometric identification verification platform may further provide scoring as to the biometric and/or biometric resolution provided at the BSP. This is a technical solution to both limit the exchange of biometric data, enhance security, and improve assurance related to the same.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, from a server, a validation request for a biometric-initiated interaction between a user and a first party, the validation request including an attestation by a biometric service provider (BSP); (b) retrieving a public key for the BSP; (c) validating a signature of the attestation based on the retrieved public key; and/or (d) returning a validation result to the server, whereby the server initiates an authentication request for the biometric interaction based on the validation result.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a server, an authentication request for a biometric interaction between a user and a first party, the authentication request including an attestation by a biometric service provider (BSP); (b) submitting a validation request to a biometric identification verification platform, whereby the biometric identification verification platform attempts to validate the attestation based on a public key associated with the BSP; (c) receiving a validation result from the biometric identification verification platform; and/or (d) transmitting, by the server, the authentication request to a directory server, whereby the authentication request to provided to an issuer of the account.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a checkout request from a first party, for a biometric interaction between the first party and a user, the checkout request including an attestation, which includes a biometric ID and a signature by a biometric service provider (BSP); (b) retrieving account detail based on the biometric ID; (c) transmitting an authentication request to a 3DS server, whereby the 3DS server validates the attestation with a biometric identification verification platform; (d) receiving an authentication response, which is based on the attestation being validated; and/or (e) initiating an authorization of the biometric interaction based on the authentication response.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving an authentication request from a 3DS server, for authentication of a user in connection with a biometric-initiated transaction, the authentication request including an attestation, which includes a biometric ID, signed by a biometric service provider (BSP); (b) validating the attestation based on a public key from the BSP; and/or (c) returning an authentication response, which is based on the attestation being validated, whereby a first party associated with the 3DS server initiates authorization of the biometric-initiated transaction based on the authentication response.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art, that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for facilitating network interactions based on user biometrics, the method comprising:
receiving, from a server, a validation request for a biometric-initiated interaction between a user and a first party, the validation request including an attestation by a biometric service provider (BSP);
retrieving, by a computing device, a public key for the BSP;
validating, by the computing device, a signature of the attestation based on the retrieved public key; and
returning, by the computing device, a validation result to the server, whereby the server initiates an authentication request for the biometric interaction based on the validation result.

2. The computer-implement method of claim 1, wherein the attestation includes a biometric ID for the user, and a currency and an amount of the biometric-initiated interaction; and
wherein the server is a 3DS server consistent with the EMV 3DS protocol for enhanced authentication.

3. The computer-implement method of claim 1, wherein the attestation includes a BSP identifier (ID) for the BSP; and
wherein retrieving the public key includes retrieving the public key based on the BSP ID.

4. The computer-implement method of claim 3, further comprising:
receiving, by the computing device, the public key from the BSP, as part of onboarding the BSP; and
storing the public key linked to the BSP ID in a memory of the computing device.

5. The computer-implement method of claim 1, further comprising, as part of enrollment of the user for biometric interactions, prior to said biometric interaction:
receiving a BSP attestation from the server;
retrieving, by the computing device, the public key for the BSP;
validating, by the computing device, a signature of the BSP attestation based on the retrieved public key; and
returning, by the computing device, a validation result for the BSP attestation to the server.

6. The computer-implement method of claim 1, wherein the attestation is devoid of data that represents a biometric of the user.

7. The computer-implement method of claim 1, wherein the validation result includes a biometric identifier (ID) stored in the computing device during enrollment of the user.

8. A computer-implemented method for facilitating network interactions based on user biometrics, the method comprising:
receiving, at a server, an authentication request for a biometric interaction between a user and a first party, the authentication request including an attestation by a biometric service provider (BSP);
submitting, by the server, a validation request to a biometric identification verification platform, whereby the biometric identification verification platform attempts to validate the attestation based on a public key associated with the BSP;
receiving, by the server, a validation result from the biometric identification verification platform; and
transmitting, by the server, the authentication request to a directory server, whereby the authentication request to provided to an issuer of the account.

9. The computer-implement method of claim 8, wherein the attestation includes a biometric ID for the user, and a currency and an amount of the biometric interaction.

10. The computer-implement method of claim 9, wherein the attestation includes a BSP identifier (ID) for the BSP; and
wherein the method further comprises retrieving the public key based on the BSP ID.

11. The computer-implement method of claim 8, wherein the attestation is devoid of data that represents a biometric of the user.

12. A computer-implemented method for facilitating network interactions based on user biometrics, the method comprising:
receiving, at a service provider, a checkout request from a first party, for a biometric interaction between the first party and a user, the checkout request including an attestation, which includes a biometric ID and a signature by a biometric service provider (BSP);
retrieving, by the service provider, account detail based on the biometric ID;
transmitting, by the service provider, an authentication request to a 3DS server, whereby the 3DS server validates the attestation with a biometric identification verification platform;
receiving, by the service provider, an authentication response, which is based on the attestation being validated; and
initiating an authorization of the biometric interaction based on the authentication response.

13. The computer-implement method of claim 12, wherein the attestation includes a biometric ID for the user, and a currency and an amount of the biometric interaction.

14. The computer-implement method of claim 12, wherein the attestation is devoid of data that represents a biometric of the user.

15. A computer-implemented method for facilitating network interactions based on user biometrics, the method comprising:
receiving, at a directory server, an authentication request from a 3DS server, for authentication of a user in connection with a biometric-initiated transaction, the authentication request including an attestation, which includes a biometric ID, signed by a biometric service provider (BSP);
validating, by the directory server, the attestation based on a public key from the BSP; and
returning, by the directory server, to the 3DS server, an authentication response, which is based on the attestation being validated, whereby a first party associated with the 3DS server initiates authorization of the biometric-initiated transaction based on the authentication response.

16. The computer-implemented method of claim 15, wherein validating the attestation includes:
retrieving, by the computing device, the public key specific to the BSP, based on a BSP ID included in the attestation; and
validating, by the computing device, the signature on the attestation based on the retrieved public key.

17. The computer-implemented method of claim 15, wherein validating the attestation includes:
transmitting, by the directory server, the attestation to a biometric identification verification platform, whereby the biometric identification verification platform validates the signature on the attestation with the public key included in the biometric identification verification platform; and
receiving, by the directory server, from the biometric identification verification platform, a validation result.

18. The computer-implemented method of claim 17, further comprising:
retrieving, by the biometric identification verification platform, the public key from a memory;
validating, by the biometric identification verification platform, the signature on the attestation based on the retrieved public key; and
based on a successful validation, transmitting a validation result indicative of the successful validation, to the directory server.

19. The computer-implemented method of claim 18, wherein the attestation is signed by a private key of the BSP;
wherein the private key and the public key define a key pair; and
wherein transmitting the validation result includes transmitting the validation result via an API to the directory server.

20. The computer-implemented method of claim 18, further comprising:
receiving, by the biometric identification verification platform, the public key from the BSP, as part of enrollment of the BSP with the biometric identification verification platform; and
storing the public key in the memory.
